(19) United States
(12) Patent Application Publication
(10) Pub. No.: US 2018/0161703 A1
(43) Pub. Date: Jun. 14, 2018

(54) FILTER ELEMENT

(71) Applicant: RT-FILTERTECHNIK GMBH, Friedrichshafen (DE)

(72) Inventors: Marco BAUTZ, Friedrichshafen (DE); Gerhard STEHLE, Konstanz (DE)

(21) Appl. No.: 15/579,289

(22) PCT Filed: Apr. 19, 2016
(86) PCT No.: PCT/EP2016/000632

§ 371 Date: Dec. 4, 2017

(30) Foreign Application Priority Data
Jun. 9, 2015 (DE) 10 2015 007 692.2

(51) Int. Cl. B01D 29/23; B01D 35/027; B01D 35/147

(52) U.S. Cl. CPC B01D 29/232; B01D 35/0276; B01D 35/147; B01D 2201/4053; B01D 2201/291; B01D 2201/4015; B01D 2201/122

(57) ABSTRACT

The invention relates to a filter element consisting of at least two end caps (3, 5), between which extends a filter material (7), characterized in that the end caps (3, 5) have connection geometries (11, 13) for the connection to third components, the connection geometries differing from one another.

The invention concerns a filter element, comprised of at least two end caps between which a filter material extends.

Filter elements of this kind are known from the prior art in a plurality of designs and with different specifications, such as filter fineness, filter surface and various other parameters. Such filter elements are used for the filtration of process liquids, pressure fluids such as hydraulic oils, liquid fuel and lubricants and for the processing of liquid media and such like. The operational reliability of corresponding filter devices in which the filter elements are used depends to a significant degree on the fact that the installed filter elements, or those filter elements that are replaced after certain operational phases, meet the exact required specifications. Reduced performance or complete failure of filter devices that are taken into operation with unsuitable filters may cause operating malfunctions or even equipment damage and result in significant economic losses if an expensive plant is involved.

Based on this problem it is the object of the invention to provide a filter element that makes an improved operational reliability of respective filter devices possible.

According to claim 1 this object is met by a filter element according to the invention, the end caps of which are provided with different connection geometries for attachment to third-party components of respective filter devices. To this extent the filter elements provide so-called incorrect installation protection, which ensures that a filter device can only be operated with a filter element that is designed specifically for the respective application because, akin to a lock-and-key system, the fluid connection between the filter element and the filter device can only be established if the geometric design of the correct filter element matches the geometric design at the connection points of the end caps.

The arrangement in this respect may advantageously be such that the respective end cap is provided with an inner and an outer edge, wherein the filter material engages with one of its free end sections between said inner and outer edge, and wherein at least a part of the edges of the one end cap is different from correspondingly arranged edges of the other end cap.

In advantageous exemplary embodiments an end cap may have a cylindrical inner and outer edge, whereby the inner and outer edges extend coaxially.

In a particularly advantageous manner the arrangement may be such that the other end cap with its inner and outer edge is non-circular, that is, it takes the form of a polygon or is made in the manner of a Reuleaux polygon. This may advantageously take the form of a Reuleaux triangle, which is based upon an equilateral triangle, and which is a design that is proposed for the shell body of a filter element disclosed in document WO 2012/034664 A1.

The arrangement may be designed such that the other end cap is provided with a cylindrical outer edge and an inner edge in the form of a Reuleaux triangle.

In particularly advantageous embodiments, in which the respective end cap is made from a solid material, a circumferential seal each of an elastomeric material is applied through injection moulding. The process may advantageously be such that, through the applied elastomeric material, axial as well as radial soft-seals are formed with respect to attachment wedges [sic] of a corresponding filter device, as well as a seal with respect to the filter material that is accepted at the respective end cap.

With respect to the design of the end caps, the arrangement may be such that the other of the two end caps is pulled into the filter element in a dome-shape, and that said dome-end is provided with fluid passages. The inner space of the dome, which is connected via the fluid passages with the respective filter cavity, is advantageously suited as installation space for a bypass valve.

Moreover, according to claim 8 it is also an object of the invention to provide a filter device that comprises two attachment parts, which are connected to each other through a perforated support tube that also maintains a certain distance between them, and which serve the purpose of accepting the filter element according to one of the preceding claims as separate component.

In a filter device of this kind the arrangement may advantageously be such that, by means of a further attachment part, which can be connected to the one attachment part, preferably by means of a bayonet lock, the filter element is pressed against the other attachment part through the effect of an energy accumulator. The other attachment part may, particularly advantageously, be provided with a bypass valve.

The invention will now be described by way of an exemplary embodiment depicted in the drawing.

Shown are in:

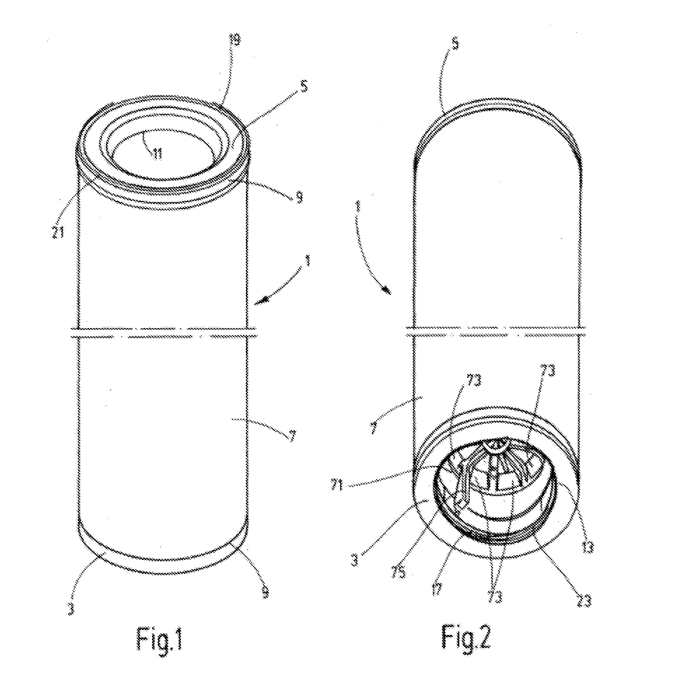

FIGS. 1 and 2 perspective views, shown reduced in length, of an exemplary embodiment of the filter element according to the invention, with view of the upper and lower end caps respectively;

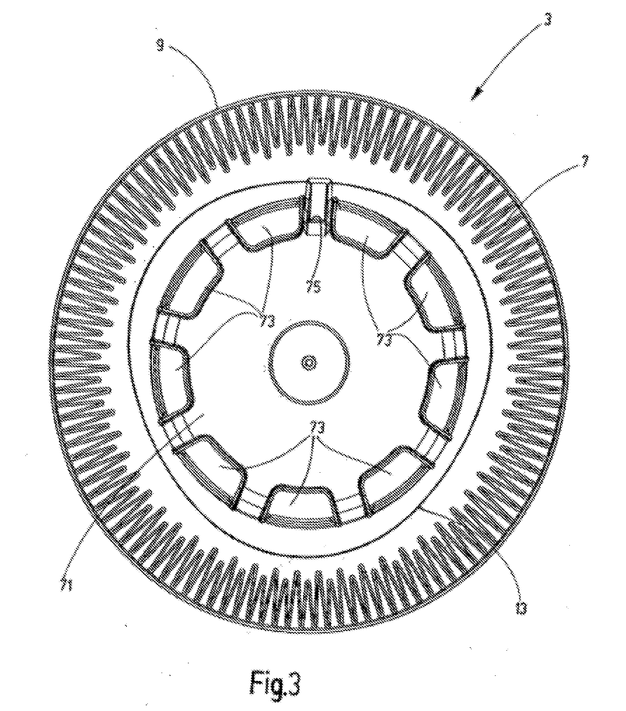

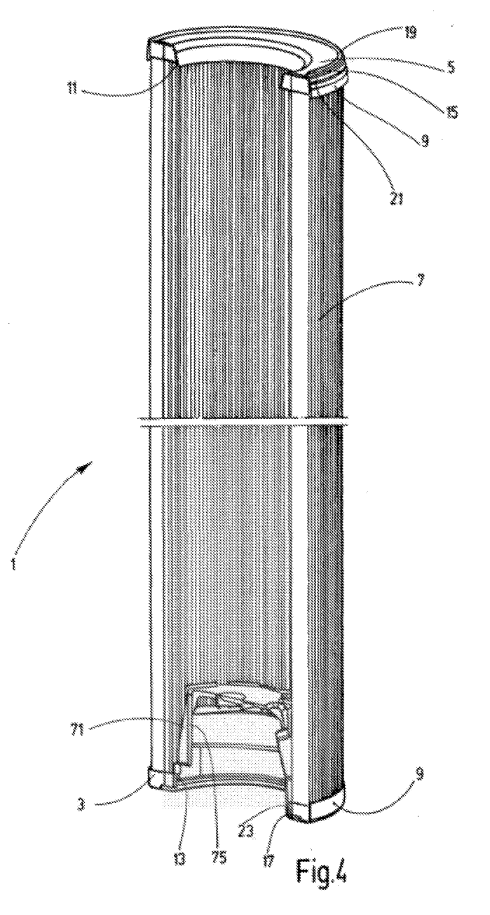

FIG. 3 a cross-section of the lower end cap with polygonal outline of the inner edge that extends along the inside of the pleating of a filter material;

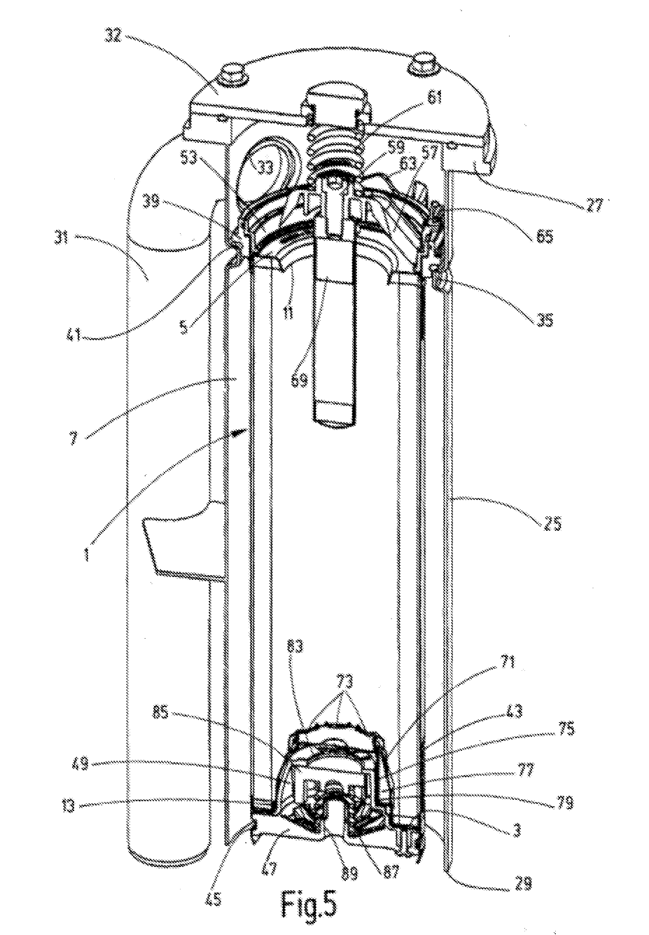

FIG. 4 a longitudinal cross-section, shown reduced in length, of the exemplary embodiment of the filter element;

FIG. 5 a longitudinal cross-section of a filter device that accepts the exemplary embodiment of the filter element;

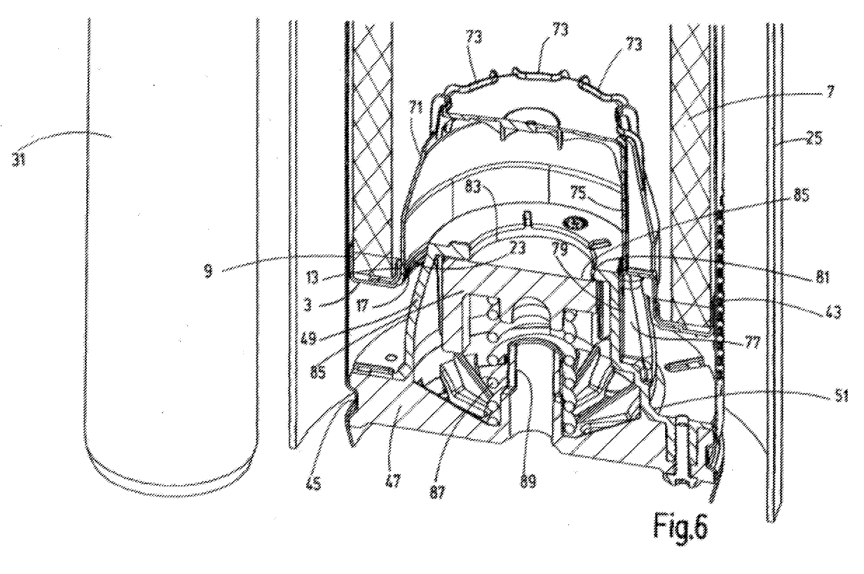

FIG. 6 a partial longitudinal cross-section of the lower end section of the filter element inserted into the filter device, shown in a larger scale compared to FIG. 5;

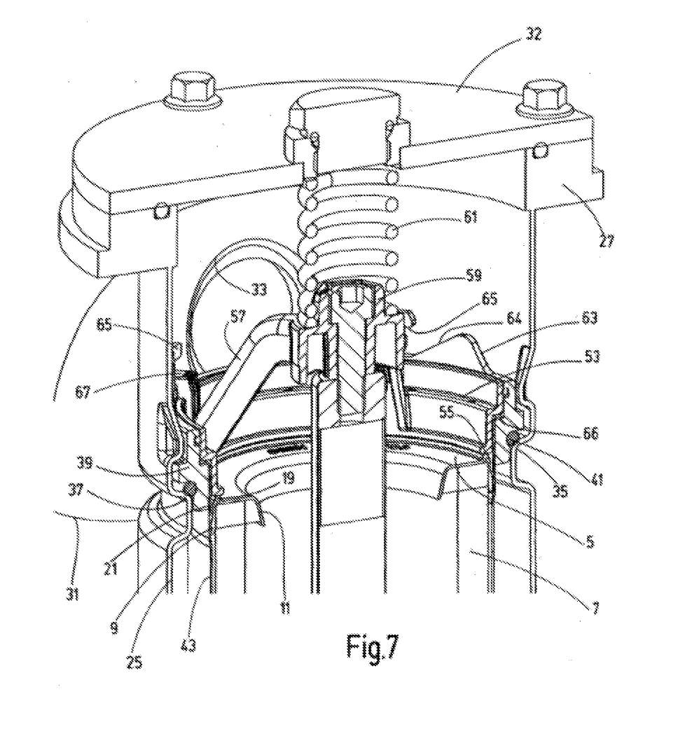

FIG. 7 a partial longitudinal cross-section of the upper end section of the filter element inserted into the filter device, shown in the same scale [sic] as FIG. 5;

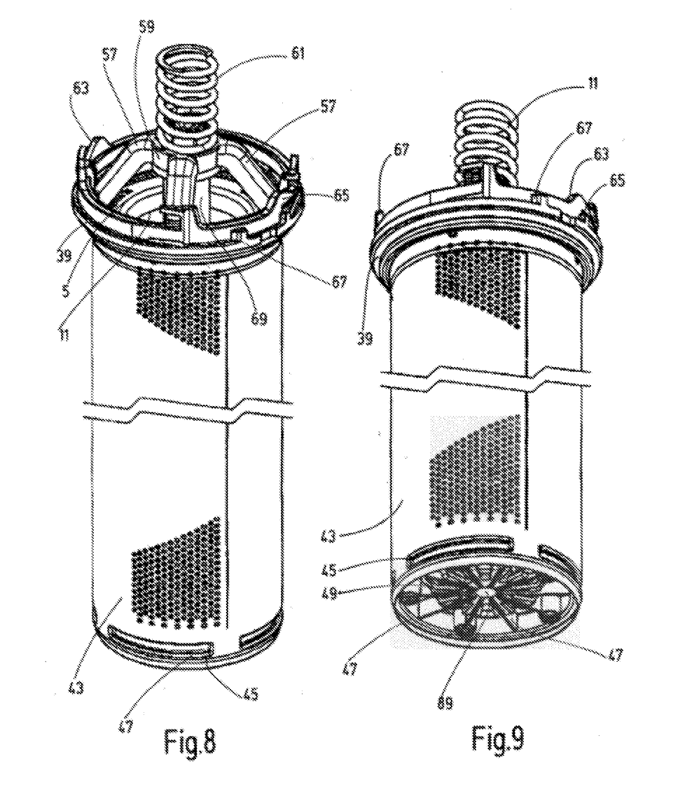

FIGS. 8 and 9 a perspective view of the exemplary embodiment of the filter element according to the invention, shown reduced in length, with associated attachment parts provided for installation into the respective filter device, with view of the upper and lower end caps respectively, and

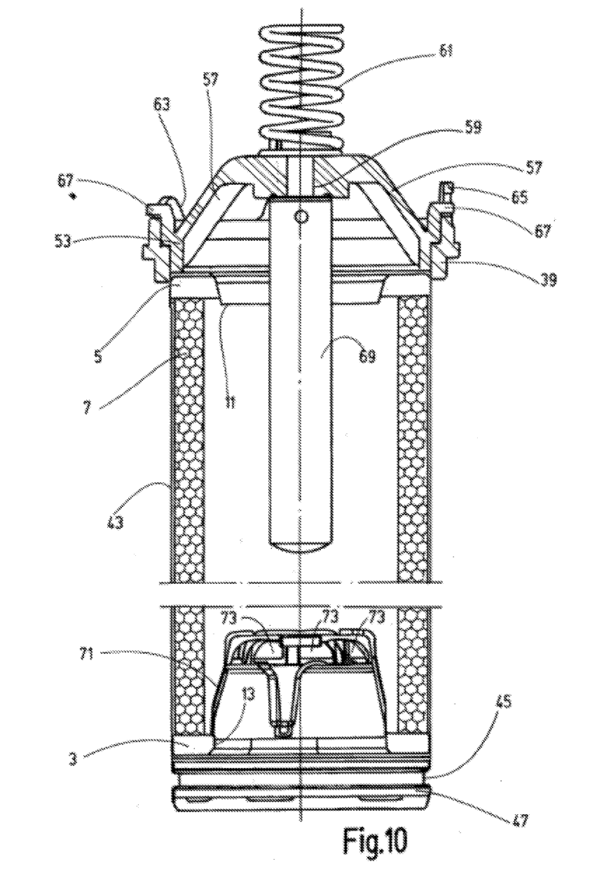

FIG. 10 a shortened, schematically simplified diagram of a longitudinal section of the filter element with attachment parts, but without bypass valve.

In the attached drawings, in which the FIGS. 1 to 4 show an exemplary embodiment of the filter element 1 according to the invention in a separated representation, that is, without associated filter device, the lower end cap is referenced with 3 and the upper end cap with 5. As shown in the depiction of the lower end cap 3, most clearly illustrated in FIG. 3, the two end caps 3, 5 form the surround for the respective end of a filter material 7, which forms a hollow cylinder, which in the current example is shown as a folded mesh pack. Both end caps 3 and 5 are provided with a circular-cylindrical outer edge 9 with which, in the example shown, the filter material 7 is in contact.

However, the filter material 7 does not necessarily have to be in contact with an edge of the end cap 3, 5. Whilst the upper end cap 5 is also provided with a circular-cylindrical inner edge 11, the lower end cap 3 (see FIG. 3) has an inner edge 13 in form of a polygon, in the example shown in form of a Reuleaux triangle.

Both end caps 3 and 5 are provided with a circumferential seal 17 and 15 respectively, which are injected as an elastic material onto the rigid material that forms the end cap 3, 5. As depicted in FIGS. 1 and 4, the seal 15 at the upper end cap 5 is injected in such a way that it forms an axial sealing surface 19 as well as a radial sealing surface 21. At the lower end cap 3 the seal 17 is injected so that at least a radial sealing edge 23 is formed. As is clearly apparent from FIGS. 6 and 7, which show the installation details of the filter element 1 into a filter device, the sealing surfaces 19, 21 and 23 serve to form seals at the attachment parts with which the filter element may be positioned inside the respective filter device.

The exemplary embodiment of the filter element 1 described here is designed for use with a so-called in-tank filter device, which (see FIGS. 5 to 7 and 10) comprises a relatively thin-walled, circular-cylindrical filter housing 25, is provided at the upper end with a flange 27 with which it is attached to an upper tank opening (not shown) in such a way that the lower, open end 29 of housing 25 extends into the tank to a level that is below the operational fluid level. At the upper end the housing 25 may be closed with a lid 32 that is screwed to the flange 27. Close to the flange 27 a supply pipe 31 is joined via an inflow opening 33 onto the housing 25. A flange 35 is formed into the wall of the filter housing 25 below the inflow opening 33, which is shaped such that at a radially constricted section a kind of step or flank 37 is formed (FIG. 7) at which a stepped, annular body 39 is braced downwards against an axial movement via a seal 41.

When comparing FIGS. 6 and 7 it is apparent that said stepped, annular body 39 is attached to a perforated support tube 43, which is in contact with the outside of the filter material 7 and which extends to the lower, open end of the filter housing 25. As shown in FIG. 6, a flange 45 is provided at the lower end of support tube 43 through which a rigid bottom section 47 is attached to the support tube 43. The annular body 39 and the bottom section 47 together with the support tube 49 thus form a kind of inner housing for the filter element 1, which can be inserted from the top. When the filter element 1 is inserted, as shown in FIG. 5, that is, when the filter element 1 is moved down axially from a partially inserted position, as shown in FIG. 6, the bottom section 47 together with a bypass valve housing 49 that is screwed to said bottom section 47 forms a lower attachment part for the lower end cap 3 of filter element 1.

In order to form a type of lock-and-key system, the outer circumference of the bypass valve housing 49 has a polygonal form in the connection or sealing section 51, which corresponds to the Reuleaux triangle at the inner edge 13 of the end cap 3, so that the seal 17 with the radial sealing surface 23 in the connection section of the end cap 3 forms the seal in the sealing section 51 of the attachment part that is formed by bottom section 47 and bypass valve housing 49 (see FIG. 6). If the polygonal shapes of the inner edge 13 of end cap 3 and the outer circumference of the bypass valve housing 49, which forms the sealing section 51, as the lower attachment part of the filter element 1, do not match, said filter element 1 is prevented from being inserted into the operating position. This creates an effective incorrect installation protection, which prevents the use of an unsuitable filter element for a respective application.

Provided as a further, third attachment part, with which the filter element 1 is retained in the installed operating position at the lower, second attachment part, that is, the bottom section 47 with bypass valve housing 49, is a retaining ring 53 that engages with the stepped inner circumference of the annular body 39 that forms the first, upper attachment part. Said retaining ring 53 is provided with a stepped shape that corresponds with the inside of the annular body 39 and is in contact with its inner, lower edge 55 with the sealing surface 19 of the end cap 5 when in operating position. Single-piece web sections 57 extend from the inside of the retaining ring 53 in radial direction towards the inside and at an angle upwards to a centrally located spring support 59, against which a compression spring 61 is braced, wherein the other end of said spring presses against the housing cover 32 and thus applies pressure onto the retaining ring 53 axially downwards, moving it in this direction to a maximum possible position where a step of the retaining ring 53 makes contact with a step 66 of the annular body 39. The annular body 39 that forms the upper attachment part, and thus with it the inner housing formed by the support tube 43, is secured to the outer filter housing 25 via the step that is formed on the outside of the retaining ring 53, wherein the sealing ring 41 provides the seal. At the same time the lower edge 55 of the retaining ring 53, through contact with the sealing surface 19 of the end cap 5, positions the filter element 1 at the lower attachment part under the effect of the spring force of the compression spring 61.

The step 66 on the annular body 39 serves, moreover, as a contact point for the support tube 43 at its upper free end which, for this purpose, is folded outwards 90 degrees. Moreover, the support tube 43 is provided below the annular body 39 with an outward-pointing circumferential flange, so that the support tube 43 has a positive seat on the annular body 39 above and below the same and to that extent forms with it a functional unit into which the filter element 1 can be inserted or placed into in particular.

As can be most clearly seen in FIGS. 7 to 10, the upper circumferential edge of the annular body 39 is provided with circumferential cam track 63, which extends with multiple flanks 64 outside the range of the latching or locking hooks 65, which protrude upwards from the cam track 63. In conjunction with the lobes 67 (FIG. 10), which project from the upper end of the retaining ring 53 radially outwards, and a twisting motion of the retaining ring 53 along the cam track 63 by means of the web sections 57, a kind of bayonet connection may be formed between the annular body 39 as the first attachment part and the retaining ring 53 as the second, upper attachment part.

The attachment web sections 57 are thus connected to the retaining ring 53 in one piece, and assigned to each attachment web section 57 is a lobe 67 (FIG. 10) which, through turning of the retaining ring 53 across the attachment web sections 57 counter-clockwise by hand, can engage with the lateral-facing openings of the respective locking hook 65. That means that assigned to each lobe 67 is also a locking hook 65, which are preferably arranged diametrically opposed to the longitudinal axis of the filter device and in equal, radial distances from each other on the retaining ring 53.

There are in particular three attachment web sections 57 besides lobes 67 and locking hooks 65. The centres of the individual attachment web sections 57 are connected to each other by a single-piece plate that extends horizontally in installation position and, due to the force of the compression spring 61, which when installed is braced under tension against the inside of the tank housing lid 32, according to the depiction in

FIG. 10, the retaining ring 53 is pressed downwards, and the lower end face of the retaining ring 53 presses further against the elastically flexible sealing ring 15 of the upper, rigid end cap 5. Nevertheless, for this contact pressure effect it is necessary that a small axial play remains between the stepped widening of the retaining ring 53 with respect to the step 66 of the annular body 39 besides the folded, perforated support tube 43. Moreover, according to the depiction in FIG. 7, a circumferential sealing ring is located in a radial recess of the annular body 39 at its upper end at the each other facing end faces of retaining ring 53 and annular body 39. In the above-described downwards movement the lower, rigid end cap 3 is moved at the same time via the rigid filter element material 7 of filter element 1, and the sealing ring 17 with its elastically flexible sealing edge 23 makes contact with the outside of the bypass valve housing 49 and provides a seal. To this extent the filter element 1 is secured via the compression spring 61 inside the support tube housing 43 in such a way that the inner unfiltrate side is separated from the outer filtrate side by the in-between-located, fluid-permeable, pleated filter element material 7 in an otherwise sealed manner.

In the instance that the housing cover 32 is removed, the compression spring 61 expands and the lobes 61 [sic] move inside the free lock opening of the locking hooks 65 upwards (not shown) under the tension of the sealing rings 15, 17 at the end caps 5 and 3 respectively. To this extent it is possible to remove the retaining ring 53 with its step from the annular body 39 in axial direction upwards. Through a subsequent, simple twisting movement by hand, now in clockwise direction, the latching lobes 65 [sic] disengage from the associated locking hook 65 that overlaps each lobe and move subsequently with a further twisting movement towards the adjoining cams 64 of the cam track 63, which causes the retaining ring 53 to follow a kind of forced movement seen in axial direction, so that the retaining ring 53 moves further away from the annular body 39 which, as a component of the housing 25, still remains in said housing. If the retaining ring 53 is completely removed from the housing 25, the filter element 1 can be removed by hand from the support tube housing 43, which for example is necessary when replacing a dirty, used element with a clean, new element. To that extent the cams 64 of the cam track 63 serve the purpose of a removal aid for the filter element 1. As is further depicted in FIGS. 5 and 7, attached to the spring support 59 is a permanent magnet rod 69, which extends from there in axial direction into the inside of the filter element 1.

As can be seen most clearly in FIGS. 2 and 6, the lower end cap 3 is provided with an inner body in form of a dome 71 that extends from the polygon-shaped inner edge 13, wherein said dome 71 extends in axial direction into the inner filter cavity and is provided at its upper end with a crown of fluid passages 73. As a result of a constricted wall section on the inside, the dome 71 forms a ridge 75 that extends in axial direction.

The bypass valve housing 49, which extends into the dome 71 when filter element 1 is in its inserted operating position, has an external shape that corresponds to the inner shape of dome 71 and is provided on the outside with a groove-like wall recess 77, which (see FIG. 6) forms a sliding surface 79, along which the ridge 75 of the dome 71 is guided in the instance where the filter element 1 is inserted downwards from the starting position, shown in FIG. 6, into the operating position. Thus the ridge 75, in conjunction with the sliding surface 79, forms on the recess 77 of the bypass valve housing 49 a rotating position, which aligns the polygon at the inner edge 13 of end cap 3 congruent to the polygonal shape at the sealing section 51 of the bypass valve housing 49. The latter forms at the inner edge 81 of an upper housing opening 83 a valve seat for making contact with a valve body 85 of the bypass valve. The valve body 85 is pre-tensioned by a valve spring 87, which rests on a socket 89 located in the bottom section 47. Moreover, with the filter element 1 installed, the outer wall of the valve housing 49 forms the sealing seat with the lower sealing ring 17 with circumferential sealing edge 23 of the lower end cap 3.

With the filter element 1 in operation in the depicted in-tank filter device, the fluid flows via the inflow opening 33 at the front of the filter element 1 to the internal filter cavity, which forms the raw filtrate or unfiltrate side, via the opening at the inner edge 11 of end cap 5. After flowing through the filter material 7 from inside to outside to the clean side or filtrate side in the space between the support tube 43 and the housing wall 25, the filtrate is discharged at the open, lower end of the housing 25 into the tank. It is clear that the filter element 1 may not only be advantageously applicable for in-tank filter devices, but also for filters of every kind in which corresponding attachment parts for connection to end caps are provided, which have a special non-circular shape at the filter element.

Whilst the present example shows a Reuleaux polygon in which the polygon shape is provided at the lower end cap 3 and the connection at the upper end cap 5 is circular-cylindrical, both end caps 3 and 5 may be provided with polygonal shapes that differ from each other, or the lower end cap 3 may have a circular-cylindrical connection geometry, whilst the polygonal shape is provided at the upper end cap 5. In contrast to the present example it is possible to provide the polygon-shaped connection geometry not at the inner edge 13 of the end cap 3, but it may be provided at the outer edge of one or both end caps, or at one end cap at the inner edge and at the other end cap at the outer edge. Moreover, it is possible to provide end caps with characteristic, from each other differing polygonal shapes.

1. A filter element, comprised of at least two end caps (3, 5), between which a filter material (7) extends, characterized in that the end caps (3, 5) are provided with differing connection geometries (11, 13) for connection with third-party components (47, 49).

2. The filter element according to claim 1, characterized in that the respective end cap (3, 5) is provided with an inner edge (11, 13) and an outer edge (9), wherein the filter material (7) engages with one of its free end sections between said inner and outer edge, and wherein at least a part (13) of the edges (9, 11, 13) of the one end cap (3) is different from correspondingly arranged edges (9, 11) of the other end cap (5).

3. The filter element according to claim 1, characterized in that the one end cap (5) has a cylindrical inner (11) and outer edge (9), wherein the inner and outer edges extend coaxially to each other.

4. The filter element according to claim 1, characterized in that the other end cap (3) with its inner (13) and/or outer edge is non-circular, taking the form of a polygon or a type of curve of constant width or is made in the manner of a Reuleaux polygon.

5. The filter element according to claim 1, characterized in that the other end cap (5) is provided with a cylindrical outer edge (9) and has an inner edge in the form of a Reuleaux triangle.

6. The filter element according to claim 1, characterized in that the respective end cap (3, 5) is made from a solid material.

7. The filter element according to claim 1, characterized in that on at least one of the two end caps (3, 5) a circumferential seal (15, 17) from an elastomeric material is applied through injection moulding or is attached to said end cap.

8. The filter element according to claim 1, characterized in that the other (3) of the two end caps (3, 5) is pulled into the inside of the filter element (1) in a dome-shape (71), and that said dome-end is provided with fluid passages (73).

9. A filter device comprising two attachment parts (39, 47), which are connected to each other through a perforated support tube (43) that also maintains a certain distance between them and which serve the purpose of accepting the filter element (1) according to claim 1 as separate component.

10. The filter device according to claim 9, characterized in that, by means of a further attachment part (53), which can be connected to the one attachment part (39), preferably by means of a bayonet lock (65, 67), the filter element (1) is pressed against the other attachment part (47) through the effect of an energy accumulator (61).

11. The filter device according to claim 9, characterized in that the other attachment part (47) comprises a bypass valve (49).
